(19) United States
(12) Patent Application Publication
(10) Pub. No.: US 2026/0103613 A1
(43) Pub. Date: Apr. 16, 2026

(54) INK SET, INK JET RECORDING METHOD AND INK JET RECORDING APPARATUS

(71) Applicant: CANON KABUSHIKI KAISHA, Tokyo (JP)

(72) Inventors: KENTARO YOSHIZAWA, Kanagawa (JP); SHINYA YUMOTO, Kanagawa (JP); MAMIKO KAJI, Kanagawa (JP)

(21) Appl. No.: 19/356,367

(22) Filed: Oct. 13, 2025

(30) Foreign Application Priority Data
Oct. 15, 2024 (JP) 2024-179615
Sep. 30, 2025 (JP) 2025-164059

(51) Int. Cl. C09D 11/40; B41J 11/00; B41M 3/00; B41M 5/00; C09D 11/38; C09D 11/54

(52) U.S. Cl. CPC C09D 11/40; B41J 11/0015; B41M 3/001; B41M 5/0011; C09D 11/38; C09D 11/54

(57) ABSTRACT

An ink set containing an aqueous ink and a reaction liquid that hardly causes white turbidity due to heat and aging in the reaction liquid and is capable of recording an image having favorable abrasion resistance and water abrasion resistance is provided. The ink set is an ink set used in an ink jet recording method for recording an image on a recording medium by using an aqueous ink, and an aqueous reaction liquid containing a reactant reacting with the aqueous ink. The aqueous ink contains a resin. The reactant contains at least one selected from the group consisting of a polyvalent metal salt and a cationic resin. The reaction liquid further contains an ionic surfactant, and a crosslinking agent capable of forming a bond with the resin in the aqueous ink.

### BACKGROUND

### Field of the Technology

The present disclosure relates to an ink set, an ink jet recording method and an ink jet recording apparatus.

### Description of the Related Art

An ink jet recording apparatus is an apparatus for recording an image on a recording medium by ejecting fine ink droplets from an ejection orifice of a recording head. In recent years, recording an image on a recording medium that has low aqueous ink absorbability or a recording medium that hardly absorbs an aqueous ink is desired. Examples of the recording medium having low aqueous ink absorbability (hereinafter, also referred to as “low-absorbable recording medium”) include recording media having a coating layer, such as art paper and coated paper. Examples of the recording medium that hardly absorbs an aqueous ink (hereinafter, also referred to as “non-absorbable recording medium”) include plastic films.

As for the ink, use of an aqueous ink containing a pigment (hereinafter, also referred to as “pigment ink”) has been examined, from the viewpoint of the environment and safety. So far, in a recording medium easily absorbing an aqueous ink, such as a recording medium having no coating layer (e.g., plain paper), high-definition image quality is obtained by using the pigment ink. Meanwhile, with respect to the low-absorbable recording medium and the non-absorbable recording medium, the applied ink droplet hardly permeates the recording medium, so that the adjacent ink droplet is applied while the fixation of the ink by permeation is almost not occurring. As a result, ink droplets are joined together to cause bleeding or unevenness, so that high-definition image quality is difficult to be obtained.

To solve the above problem, for example, Japanese Patent Laid-Open No. 2012-233161 proposes a reaction liquid containing a polyvalent metal salt that causes aggregation and thickening by reacting with a component in the ink, such as a pigment.

In addition, in a recorded matter recorded on the aforementioned low-absorbable recording medium or non-absorbable recording medium by an ink jet recording method using an aqueous ink, the presence of an image layer formed by an ink or the like on the surface of the recording medium forms an image. Thus, the abrasion resistance and fixability of the image are more desired than ever.

On the other hand, Japanese Patent Laid-Open No. 2021-112900 proposes an ink set including a first liquid composition containing a crosslinking agent and water, and an aqueous ink serving as a second liquid composition containing a pigment and a resin capable of reacting with the crosslinking agent.

### SUMMARY

Therefore, the present disclosure is directed to providing an ink set containing an aqueous ink and a reaction liquid that hardly causes white turbidity due to heat and aging in the reaction liquid and is capable of recording an image having favorable abrasion resistance and water abrasion resistance. The present disclosure is also directed to providing an ink jet recording method and ink jet recording apparatus capable of using the ink set.

That is, according to an aspect of the present disclosure, there is provided an ink set used in an ink jet recording method for recording an image on a recording medium by using an aqueous ink, and an aqueous reaction liquid containing a reactant reacting with the aqueous ink, the ink set containing the aqueous ink and the reaction liquid, wherein the aqueous ink contains a resin, the reactant contains at least one selected from the group consisting of a polyvalent metal salt and a cationic resin, and the reaction liquid further contains an ionic surfactant, and a crosslinking agent capable of forming a bond with the resin in the aqueous ink.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of an embodiment of the ink jet recording apparatus of the present disclosure.

FIG. 2 is a perspective view of an example of the liquid applying device.

### DESCRIPTION OF THE EMBODIMENTS

Hereinafter, the present disclosure will be described further in detail with reference to preferable embodiments. In the present disclosure, when the compound is a salt, the salt is present as a dissociated ion in the ink, which is expressed as “containing a salt”, for convenience. An aqueous ink and reaction liquid for ink jet may be simply described as “ink” and “reaction liquid”. A physical property value is a value at ambient temperature (25° C.), unless otherwise specified. The descriptions “(meth)acrylic acid” and “(meth)acrylate” respectively mean “acrylic acid and methacrylic acid” and “acrylate and methacrylate”.

When an image is recorded by a two-component reaction system that uses a reaction liquid and an ink, the reaction liquid is typically applied to a recording medium, and then the ink is applied. In the ink jet recording method of the present disclosure, the order of application of the reaction liquid and the ink is not limited to the above order. However, the order in which the reaction liquid is applied to the recording medium and then the ink is applied is preferable because the effect of the present disclosure is more easily obtained. Hereinafter, the present invention will be described by way of the order in which the reaction liquid is applied to the recording medium and then the ink is applied.

The higher the concentration of the crosslinking agent disclosed in Japanese Patent Laid-Open No. 2021-112900 in the reaction liquid is, the more the crosslinking density of an image layer formed from the ink and the reaction liquid on a recording medium increases, so that high fastness such as favorable abrasion resistance and water abrasion resistance can be expected. In addition, to obtain a high-quality image, a high-concentration polyvalent metal salt is required to be incorporated into the reaction liquid. However, the reaction liquid containing the crosslinking agent and the polyvalent metal salt in high concentration causes white turbidity depending on temperatures and is separated into two layers with time. It has been found that the layer separation leads to localization of the crosslinking agent in higher concentration, self-crosslinking of crosslinking agents, and gelation. Such a partially gelled reaction liquid as above is considered not to sufficiently exert the effect of improving the image fastness that is expected by incorporating the crosslinking agent. In addition, the ratio of the amount of the resin to the amount of the crosslinking agent on the recording medium may be an important factor in the image fastness. However, the reaction liquid separated into two layers and gelled as mentioned above has difficulty in controlling the application on the recording medium.

The present inventors have examined to obtain a recorded matter having both high image quality and fastness using an aqueous ink containing a reaction liquid containing a crosslinking agent and a polyvalent metal salt and/or a cationic resin in high concentration, and a pigment.

Specifically, in a two-part reaction system including an aqueous ink, and a reaction liquid containing a coagulant that causes a rapid viscosity change upon being brought into contact with the aqueous ink, the present inventors have examined to incorporate a resin into the ink and incorporate a crosslinking agent capable of forming a bond with the resin in the ink into the reaction liquid. Accordingly, a crosslinking structure is considered to be formed in an image layer that is formed from the ink and the reaction liquid, and fastness such as abrasion resistance and water abrasion resistance of an image to be recorded is considered to be improved. In addition, when the ratio of the amount of the resin to the amount of the crosslinking agent in an image layer falls within a certain range, it is considered that the higher the amount of the crosslinking agent is, the more easily the fastness of an image is improved.

However, as a result of the examination, the present inventors has found that respective materials cannot be hydrated in the reaction liquid containing a polyvalent metal salt and/or a cationic resin and a crosslinking agent in high concentration, and the crosslinking agent having a relatively weak interaction with water molecules is eluted, so that the entire reaction liquid is white turbid. The present inventors have also found that the degree of white turbidity is more significant with an increase in the temperature of the reaction liquid. Further, the present inventors have found that a white turbid solution causes gelation of the crosslinking agent with time and easily causes layer separation.

The present inventors have considered that accelerating the hydration of the crosslinking agent is important to suppress the elution of the aforementioned crosslinking agent in the reaction liquid. As a result of the examination, the present inventors have found that further incorporating an ionic surfactant into the reaction liquid accelerates the hydration of the crosslinking agent in the reaction liquid and enables the white turbidity of the reaction liquid to be suppressed. The present inventors consider the reason as follows.

Typically, the polyvalent metal salt, cationic resin, surfactant and the like used in the aqueous reaction liquid are dissolved by being hydrated with water molecules in the reaction liquid. On the other hand, the crosslinking agent also retains water solubility by hydration with water molecules, except for the special case such as an emulsion crosslinking agent. Thus, the higher the concentration of the polyvalent metal salt and/or cationic resin in the reaction liquid is, the more easily the crosslinking agent having a relatively weak interaction with water molecules is eluted. Then, an ionic surfactant is added to the reaction liquid as a solubilizer. In the reaction liquid, the ionic surfactant forms an associated product such as a micelle by directing the hydrophobic moiety of the ionic surfactant inward and the hydrophilic moiety outward. Encompassing the crosslinking agent inside the associated product is considered to improve the solubility of the crosslinking agent in the reaction liquid and to enable an increase in the concentration of the crosslinking agent.

### <Ink Set>

The ink set of the present disclosure is a set containing an aqueous ink and an aqueous reaction liquid. The ink set is used in an ink jet recording method for recording an image on a recording medium using the aqueous ink and the reaction liquid. The reaction liquid contains a reactant reacting with the aqueous ink. The reactant contains at least one selected from the group consisting of a polyvalent metal salt and a cationic resin. The ink contains a resin. By incorporating a resin into the ink, a resin film may be formed on the recording medium. To enhance the abrasion resistance of an image, the strength of the resin film is enhanced to prevent the image from being scratched. Thus, a crosslinking agent capable of forming a bond with the resin in the ink and the aforementioned ionic surfactant are incorporated into the reaction liquid. As the resin to be incorporated into the ink, a resin capable of forming a bond with the crosslinking agent is used. By bringing the reaction liquid into contact with the ink on the recording medium, the resin in the ink can be reacted with the crosslinking agent in the reaction liquid. Hereinafter, the reaction liquid and ink that constitute the ink set will be described.

### <Reaction Liquid>

The reaction liquid is an aqueous reaction liquid containing a reactant reacting with the aqueous ink. Hereinafter, each component to be used in the reaction liquid will be described in detail.

### (Reactant)

The reaction liquid reacts with the ink by being brought into contact with the ink, aggregates components (a resin and a component having an anionic group, such as a self-dispersible pigment) in the ink, and contains a reactant. As the reactant, at least one selected from the group consisting of a polyvalent metal salt and a cationic resin is used.

As the polyvalent metal salt, a polyvalent metal salt (which may be a hydrate) formed by bonding of a polyvalent metal ion with an anion can be used. Examples of the polyvalent metal ion include divalent metal ions such as Ca²⁺, Cu²⁺, Ni²⁺, Mg²⁺, Sr²⁺, Ba²⁺ and Zn²⁺, and trivalent metal ions such as Fe³⁺, Cr³⁺, Y³⁺ and Al³⁺. Examples of the anion include inorganic anions such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻ and H₂PO₄⁻; and organic anions such as HCOO⁻, (COO⁻)₂, COOH(COO⁻), CH₃COO⁻, CH₃CH(OH)COO⁻, C₂H₄(COO⁻)₂, C₆H₅COO⁻, C₆H₄(COO⁻)₂ and CH₃SO₃⁻. One or two or more polyvalent metal salts may be incorporated into the reaction liquid. When the polyvalent metal ion is used as the reactant, the content (% by mass) in terms of polyvalent metal salt in the reaction liquid is preferably 1.0% by mass or more to 30.0% by mass or less, and more preferably 2.0% by mass or more to 30.0% by mass or less, based on the total mass of the reaction liquid. As used herein, “the content (% by mass) of the polyvalent metal salt” in the reaction liquid when the polyvalent metal salt is a hydrate means “the content (% by mass) of the anhydride of the polyvalent metal salt” excluding water serving as a hydrate.

From the viewpoint of the compatibility of the components in the reaction liquid for hardly causing white turbidity due to heat and aging in the reaction liquid, the standard enthalpy of formation of the anion constituting the polyvalent metal salt is preferably −1,000 kJmol⁻¹ or more to −200 kJmol⁻¹ or less. With respect to the method for calculating the standard enthalpy of formation of the anion, calculation is made by setting the standard enthalpy of formation of the anion to 298.15 K, with reference to “Handbook of Chemistry: Pure Chemistry” (Maruzen Publishing). The standard enthalpies of formation of representative anions are SO₄²⁻: −909.34 kJmol⁻¹, Cl⁻: −167.08 kJmol⁻¹ and PO₄³⁻: −1018.7 kJmol⁻¹.

When the reaction liquid contains the polyvalent metal salt, the polyvalent metal salt preferably contains a sulfate ion (SO₄²⁻), from the viewpoint of further easily improving the abrasion resistance and water abrasion resistance of an image. From the viewpoint of further easily improving the abrasion resistance and water abrasion resistance of an image and the compatibility of the components in the reaction liquid for hardly causing white turbidity due to heat and aging in the reaction liquid, the polyvalent metal salt is more preferably magnesium sulfate.

Examples of the cationic resin include resins having any of primary to tertiary amine structures and resins having a quaternary ammonium salt structure. Specific examples thereof include resins having a structure such as vinyl amine, allyl amine, vinyl imidazole, vinyl pyridine, dimethylaminoethyl methacrylate, ethyleneimine and guanidine. One or two or more cationic resins may be incorporated into the reaction liquid. To enhance the solubility in the reaction liquid, the cationic resin and an acidic compound can be used in combination, or the cationic resin can be subjected to quaternization treatment. When the cationic resin is used as the reactant, the content (% by mass) of the cationic resin in the reaction liquid is preferably 1.0% by mass or more to 10.0% by mass or less, based on the total mass of the reaction liquid.

The reaction liquid may further contain another reactant, if necessary, in addition to the polyvalent metal salt and/or the cationic resin. Examples of another reactant include an organic acid. The reaction liquid containing an organic acid has buffer capacity in an acidic region (less than pH 7.0, preferably pH 2.0 to 5.0), thereby efficiently making the anionic group of the components in the ink acidic for aggregation.

Examples of the organic acid include monocarboxylic acids such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid and coumalic acid, and salts thereof; dicarboxylic acids such as oxalic acid, malonic acid, succinic acid, glutaric acid, adipic acid, maleic acid, fumaric acid, itaconic acid, sebacic acid, phthalic acid, malic acid and tartaric acid, and salts and hydrogen salts thereof; tricarboxylic acids such as citric acid and trimellitic acid, and salts and hydrogen salts thereof; and tetracarboxylic acids such as pyromellitic acid, and salts and hydrogen salts thereof. One or two or more organic acids may be incorporated into the reaction liquid. When the organic acid is further used as the reactant, the content (% by mass) of the organic acid in the reaction liquid is preferably 1.0% by mass or more to 40.0% by mass or less, based on the total mass of the reaction liquid.

The content (% by mass) of the reactant in the reaction liquid is preferably 1.0% by mass or more to 35.0% by mass or less, and more preferably 2.0% by mass or more to 30.0% by mass or less, based on the total mass of the reaction liquid. From the viewpoint of easily suppressing a phenomenon in which the ink bleeds (feathering) along the fiber of the recording medium in the image, the above content of the reactant is more preferably 2.0% by mass or more, and still more preferably 2.5% by mass or more. On the other hand, from the viewpoint of further easily enhancing the abrasion resistance and water abrasion resistance of an image, the above content of the reactant is more preferably 30.0% by mass or less, and still more preferably 25.0% by mass or less. The above content of the reactant is the total content of the polyvalent metal salt, the cationic resin, the organic acid and the like.

### (Crosslinking Agent)

The reaction liquid contains a crosslinking agent capable of forming a bond with the resin in the ink described below. The crosslinking agent is a component capable of forming a three-dimensional network structure by reacting with the resin in the ink. The crosslinking agent is a different component from the reactant. The bond formed by the resin in the ink and the crosslinking agent is preferably a covalent bond. The crosslinking agent may be present in a dissolved state in an aqueous medium in the reaction liquid or may be present in a dissolved state as a particle in an aqueous medium in the reaction liquid. Since the crosslinking agent is contained in the reaction liquid, the crosslinking agent is separated from the resin in the ink before applying the reaction liquid and the ink to the recording medium, and the storability of the reaction liquid can be improved. Since the crosslinking agent is contained in the reaction liquid, a liquid containing the crosslinking agent is not required to be further used in addition to the reaction liquid, which is also advantageous in terms of the number of types of ink cartridges to be used in the ink jet recording apparatus.

When the reaction liquid is used in an ink jet recording method including a drying step by heating a recording medium on which an ink and the like are applied, the glass transition temperature of the crosslinking agent is preferably lower than the heating temperature of the recording medium in the drying step. When the glass transition temperature of the crosslinking agent is lower than the heating temperature of the recording medium, the crosslinking agent is easily softened and easily brought into contact with the resin in the ink. Consequently, the crosslinking agent in the reaction liquid and the resin in the ink are easily crosslinked, the strength of the resin film is easily enhanced, so that the abrasion resistance of an image is easily enhanced. On the other hand, the glass transition temperature of the crosslinking agent is preferably more than 50° C., and more preferably 51° C. or more, from the viewpoint of the adhesion resistance of an image. Consequently, the adhesion resistance of an image is improved. The glass transition temperature can be measured by, for example, a usual method using a thermal analysis apparatus such as a differential scanning calorimeter (DSC).

The initiation temperature of the reaction between the crosslinking agent and the resin in the ink is preferably lower than the temperature of the drying conditions after recording, and is more preferably 25° C. or less.

The crosslinking agent is not particularly limited, as long as the crosslinking agent can form a bond with the resin in the ink, and an appropriate one can be selected and used depending on the purpose of use, drying conditions, the kind of recording medium and the like. The crosslinking agent is a compound having two or more functional groups capable of forming bonds with the resin and other components in the ink (hereinafter, sometimes referred to as the “crosslinkable group”). When these functional groups form bonds with the resin in the ink, a crosslinking structure (three-dimensional network structure) may be introduced into the image layer formed from the ink and the reaction liquid. When these bonds are covalent bonds, the number of hydrophilic groups in the material in the image layer is irreversibly reduced, the hydrophobicity of the image layer is improved, and water resistance and ethanol resistance are easily enhanced.

Examples of the functional group (crosslinkable group) in the crosslinking agent include a carbodiimide group, an epoxy group, an amino group, an isocyanate group, an oxazoline group, a silyl group, a halide, an aziridine group, a melanin group, an azo group and a bismaleimide group. A compound having two or more functional groups selected from the group consisting of these functional groups can be used as the crosslinking agent. The crosslinking agent may have one of the above functional groups, or may have two or more thereof. Further, the crosslinking agent may be used alone, or two or more may be used in combination.

Among the above functional groups, the crosslinking agent preferably has two or more functional groups selected from the group consisting of a carbodiimide group, an isocyanate group and an oxazoline group, from the viewpoint of improving the storability of the reaction liquid and the fastness of an image. Above all, the crosslinking agent more preferably has two or more carbodiimide groups, from the viewpoint of further easily improving the abrasion resistance of an image. Thus, at least one selected from the group consisting of a carbodiimide crosslinking agent having carbodiimide groups, an isocyanate crosslinking agent having isocyanate groups and an oxazoline group-containing crosslinking agent having oxazoline groups is preferably used as the crosslinking agent. Above all, a carbodiimide crosslinking agent is more preferably used. In view of easy availability, commercially available products can be preferably used as these crosslinking agents.

Examples of the carbodiimide crosslinking agent include trade name “CARBODILITE” (model number: V-02, V-02-L2, SV-02, V-04, V-10, E-02, E-03 and E-05 manufactured by Nisshinbo Chemical Inc.). Examples of the isocyanate crosslinking agent include trade name “ELASTRON” (model number: BN-69, BN-77 and BN-27, manufactured by DKS Co. Ltd.). Examples of the oxazoline group-containing crosslinking agent include trade name “EPOCROS” (model number: K-2010E, K-2020E, K-2035E, WS-300, WS-500 and WS-700, manufactured by NIPPON SHOKUBAI CO., LTD.).

The crosslinking agent having the aforementioned functional groups is capable of forming a bond with the resin in the ink, or, if necessary, with a component other than the resin in the ink or a hydrophilic group present on the surface of the recording medium. Examples of the hydrophilic group capable of reacting with the crosslinking agent include a carboxy group, a phenol hydroxy group, an alcohol hydroxy group, an amino group, an amide group, an aromatic thiol group, an epoxy group, a caprolactam group and an acid anhydride group. Above all, a carboxy group or an alcohol hydroxy group is preferable.

The reaction of the functional group in the crosslinking agent in the reaction liquid with the carboxy group in the resin in the ink will be described with reference to examples. When the crosslinking agent in the reaction liquid has an oxazoline group, the oxazoline group and the carboxy group in the resin form an amide ester bond, so that the resin film on the recording medium is crosslinked. When the crosslinking agent in the reaction liquid has a carbodiimide group (—N═C═N—), the carbodiimide group and the carboxy group in the resin form an N-acylurea structure, so that the resin film on the recording medium is crosslinked. Consequently, the strength of the resin film formed on the recording medium is enhanced, so that the abrasion resistance and water abrasion resistance of an image can be improved.

With respect to the number of functional groups (crosslinkable groups) constituting a molecule of the crosslinking agent, the crosslinking agent preferably has 1 mol of functional groups per molecular weight of 350 to 550, from the viewpoint of further easily enhancing the abrasion resistance and water abrasion resistance of an image. In other words, the chemical formula weight per 1 mol of functional groups in the crosslinking agent, that is, the functional group equivalent is preferably 350 or more to 550 or less.

The content (% by mass) of the crosslinking agent in the reaction liquid is preferably 1.0% by mass or more to 25.0% by mass or less, and more preferably 2.0% by mass or more to 20.0% by mass or less, based on the total mass of the reaction liquid. From the viewpoint of further easily enhancing the abrasion resistance and water abrasion resistance of an image, the above content of the crosslinking agent is more preferably 2.0% by mass or more, and still more preferably 5.0% by mass or more. On the other hand, from the viewpoint of easily suppressing the feathering of an image and enhancing the compatibility of the components in the reaction liquid, the above content of the crosslinking agent is more preferably 20.0% by mass or less, still more preferably 15.0% by mass or less.

### (Ionic Surfactant)

The reaction liquid contains an ionic surfactant. Examples of the ionic surfactant include a cationic surfactant, an anionic surfactant, and an amphoteric surfactant. As the ionic surfactant, one of these surfactants may be used alone, or two or more thereof may be used in combination. As the ionic surfactant, a compound that has a hydrophilic moiety containing a cationic group or an anionic group, or both of them, and a hydrophobic moiety serving as an aliphatic hydrocarbon group is preferably used. Above all, the ionic surfactant preferably has at least one cationic hydrophilic moiety (hydrophilic moiety containing a cationic group).

The anionic group that may be contained in the ionic surfactant is preferably at least one selected from the group consisting of a carboxylic acid group, a carboxylate group, a sulfonic acid group, a sulfate group, a phosphoric acid group, a phosphate group, a phosphonic acid group and a phosphonate group. These anionic groups may form a salt together with an alkali metal ion, an ammonium ion or an organic ammonium ion. The hydrophilic moiety may be an alkylene group, an amide group, a sulfonyl group, an imino group, a carbonyl group, an ester group, an ether group or an alkylene oxide group having any of these anionic groups, and a group obtained by combining these groups.

Examples of the cationic group that may be contained in the ionic surfactant include an amino group and a pyridine group.

Examples of the aliphatic hydrocarbon group constituting the hydrophobic moiety include linear, branched, and cyclic aliphatic hydrocarbon groups. Provided that the aliphatic hydrocarbon group has no aromatic ring. Specific examples of the aliphatic hydrocarbon group include an alkyl group, an alkenyl group, an alkynyl group, a cycloalkyl group and a cycloalkenyl group.

Specific examples of the anionic surfactant include alkylsulfonic acid, polyoxyethylene alkylether sulfate, sodium polyoxyethylene laurylether sulfate, alkyl sulfate, alkyltaurine, alkyl sulfoacetate, carboxylated polyoxyethylene alkyl ether, alkylphosphoric acid, polyoxyethylene alkyl ether phosphate, alkylphosphate, aliphatic carboxylic acid, polyoxyethylene alkyl ether carboxylic acid, N-acyl sarcosine and N-acyl glutamic acid. One of these anionic surfactants may be used alone, or two or more thereof may be used in combination.

Specific examples of the cationic surfactant include stearamidopropyl dimethylamine, steartrimonium chloride, stearoxypropyltrimonium chloride, distearyldimonium chloride, dicocoylethyl hydroxyethylmonium methosulfate and benzalkonium chloride. One of these cationic surfactants may be used alone, or two or more thereof may be used in combination.

Specific examples of the amphoteric surfactant include an amino acid amphoteric surfactant, a betaine amphoteric surfactant, a sulfate amphoteric surfactant, a sulfonate amphoteric surfactant and a phosphate amphoteric surfactant. One of these amphoteric surfactants may be used alone, or two or more thereof may be used in combination.

From the viewpoint of antibacterial and antifungal properties in the reaction liquid, the ionic surfactant preferably contains the cationic surfactant. When the ionic surfactant in the reaction liquid contains the cationic surfactant, the water abrasion resistance of an image and the compatibility of the components in the reaction liquid are further easily improved.

The content (% by mass) of the ionic surfactant in the reaction liquid is preferably 0.1% by mass or more to 4.0% by mass or less, and more preferably 0.2% by mass or more to 3.0% by mass or less, based on the total mass of the reaction liquid. From the viewpoint of further easily enhancing the water abrasion resistance of an image and easily suppressing the feathering of an image, the above content of the ionic surfactant is still more preferably 0.3% by mass or more to 1.5% by mass or less.

The reaction liquid may further contain, if necessary, a nonionic surfactant in addition to the ionic surfactant. When a nonionic surfactant is incorporated into the reaction liquid, the content (% by mass) of the nonionic surfactant in the reaction liquid is preferably 0.1% by mass or more to 2.0% by mass or less, based on the total mass of the reaction liquid.

In the reaction liquid, (A+B)/C is preferably 5.0 or more to 50.0 or less where A denotes the content (% by mass) of the reactant in the reaction liquid, B denotes the content (% by mass) of the crosslinking agent, and C denotes the content (% by mass) of the ionic surfactant in the reaction liquid, based on the total mass of the reaction liquid. When (A+B)/C is 5.0 or more, the water abrasion resistance of an image is further easily improved, and the feathering of an image is further easily suppressed. From these viewpoints, (A+B)/C is more preferably 5.5 or more, and still more preferably 6.0 or more. On the other hand, when (A+B)/C is 50.0 or less, the compatibility of the components in the reaction liquid is further easily improved and the feathering of an image is further easily suppressed. From these viewpoints, (A+B)/C is more preferably 40.0 or less, and still more preferably 30.0 or less.

### (Aqueous Medium)

The reaction liquid is an aqueous reaction liquid containing at least water as an aqueous medium. Examples of the aqueous medium to be used in the reaction liquid include the same aqueous media as the aqueous media capable of being incorporated into the ink described below. The content (% by mass) of water in the reaction liquid is preferably 50.0% by mass or more to 95.0% by mass or less, based on the total mass of the reaction liquid. The content (% by mass) of the water-soluble organic solvent in the reaction liquid is preferably 1.0% by mass or more to 45.0% by mass or less, based on the total mass of the reaction liquid. From the viewpoint of further easily improving the abrasion resistance and water abrasion resistance of an image, the reaction liquid preferably contains a water-soluble organic solvent having a boiling point of 250° C. or less. Examples of water-soluble solvents having a boiling point of 250° C. or less include ethylene glycol (boiling point 197° C.), 1,2-propanediol (boiling point 188° C.), 1,3-propanediol (boiling point 210° C.), 1,2-butanediol (boiling point 193° C.), 1,3-butanediol (boiling point 208° C.), 1,4-butanediol (boiling point 230° C.), 1,2-pentanediol (boiling point 206° C.), 1,2-hexanediol (boiling point 223° C.), 2-methyl-1,3-propanediol (boiling point 214° C.), diethylene glycol monomethyl ether (boiling point 194° C.), diethylene glycol monoethyl ether (boiling point 202° C.), diethylene glycol monoisopropyl ether (boiling point 207° C.), diethylene glycol monoisobutyl ether (boiling point 229° C.), diethylene glycol monobutyl ether (boiling point 230° C.), 1,5-pentanediol (boiling point 242° C.), diethylene glycol (boiling point 245° C.) and 2-pyrrolidone (boiling point 245° C.). One of these may be used alone, or two or more thereof may be used.

### (Other Components)

The reaction liquid may contain various other components, if necessary. Examples of other components include the same components as the other components capable of being incorporated into the ink described below.

### (Physical Properties of Reaction Liquid)

The reaction liquid is preferably an aqueous reaction liquid applied to an ink jet system. Therefore, the physical property value thereof is preferably suitably controlled, from the viewpoint of reliability. Specifically, the surface tension of the reaction liquid at 25° C. is preferably 20 mN/m or more to 60 mN/m or less. The viscosity of the reaction liquid at 25° C. is preferably 1.0 mPa·s or more to 10.0 mPa·s or less. The pH of 25° C. of the reaction liquid at 25° C. is preferably 5.0 or more to 9.5 or less, and more preferably 6.0 or more to 9.0 or less.

### <Ink>

The ink is an aqueous ink for inkjet that contains a resin. Hereinafter, each component to be used in the ink will be described in detail.

### (Coloring Material)

The ink preferably contains a coloring material. As the coloring material, a pigment or a dye can be used. The content (% by mass) of the coloring material in the ink is preferably 0.5% by mass or more to 15.0% by mass or less, and more preferably 1.0% by mass or more to 10.0% by mass or less, based on the total mass of the ink.

Specific examples of the pigment include inorganic pigments such as carbon black and titanium oxide; and organic pigments such as azo, phthalocyanine, quinacridone, isoindolinone, imidazolone, diketopyrrolopyrrole and dioxazine. The pigment may be used alone, or two or more thereof may be used in combination.

As a dispersion system for the pigment, a resin-dispersed pigment using a resin as a dispersant, a self-dispersible pigment that has a hydrophilic group bonded to the particle surface of the pigment, or the like may be used. In addition, for example, a resin-bonded pigment having a resin containing an organic group chemically bonded to the particle surface of the pigment, or a microcapsule pigment in which the particle surface of the pigment is covered with a resin or the like, can be used. Among these, pigments each having a dispersion system different from each other may be used in combination. Above all, not a resin-bonded pigment or a microcapsule pigment, but a resin-dispersed pigment in which a resin serving as a dispersant is allowed to physically adsorb to the particle surface of the pigment is preferably used.

As a resin dispersant for dispersing the pigment in the aqueous medium, a dispersant capable of dispersing the pigment in an aqueous medium through the action of an anionic group is preferably used. As the resin dispersant, a resin having an anionic group can be used, and a resin as described below, above all, a water-soluble resin is preferably used. The mass ratio of the content (% by mass) of the pigment in the ink to the content (% by mass) of the resin dispersant therein is preferably 0.3 times or more to 10.0 times or less.

As a self-dispersible pigment, a pigment having an anionic group bonded to the particle surface of the pigment directly or through another atomic group (—R—) can be used. Specific examples of another atomic group (—R—) include a linear or branched alkylene group having 1 to 12 carbon atoms; an arylene group such as a phenylene group or a naphthylene group; a carbonyl group; an imino group; an amide group; a sulfonyl group; an ester group; and an ether group. Also, a group obtained by combining these groups may be used.

As the dye, a dye having an anionic group is preferably used. Specific examples of the dye include dyes such as azo, triphenylmethane, (aza) phthalocyanine, xanthene and anthrapyridone. The dye may be used alone, or two or more thereof may be used in combination.

Examples of the above anionic group described in the description of the resin dispersant, the self-dispersible pigment and the dye include a carboxylic acid group, a sulfonic acid group and a phosphonic acid group. The anionic group may be any one of an acid type and a salt type. When the anionic group is a salt type, the group may be in any one of a state in which a part of the group is dissociated or a state in which the entire group is dissociated. When the anionic group is the salt type, examples of the cation serving as a counterion include an alkali metal cation, ammonium and organic ammonium. The coloring material to be incorporated into the ink is preferably a pigment, and more preferably a resin-dispersed pigment.

### (Resin)

The ink contains a resin. The content (% by mass) of the resin in the ink is preferably 0.1% by mass or more to 20.0% by mass or less, and more preferably 0.5% by mass or more to 15.0% by mass or less, based on the total mass of the ink.

The resin may be added to the ink (i) to stabilize the dispersed state of the pigment, that is, as a resin dispersant or an aid therefor. In addition, the resin may be added to the ink (ii) to improve the various characteristics of an image to be recorded. Examples of the form of the resin include a block copolymer, a random copolymer, a graft copolymer and a combination thereof. In addition, the resin may be a water-soluble resin that can be dissolved in an aqueous medium or may be a resin particle to be dispersed in the aqueous medium. One or two or more kinds of resins can be incorporated into the ink, and both the water-soluble resin and the resin particle may be incorporated thereinto. From the viewpoint of further easily improving the abrasion resistance and water abrasion resistance of an image and the storability of the ink, the resin in the ink preferably contains a resin particle.

### [Composition of Resin]

Examples of the resin include an acrylic resin, a urethane-based resin and an olefinic resin. Above all, an acrylic resin or a urethane-based resin is preferable, and an acrylic resin including a unit derived from (meth)acrylic acid or (meth)acrylate is more preferable.

As the acrylic resin, an acrylic resin having a hydrophilic unit and a hydrophobic unit as constituting units is preferable. Above all, a resin having a hydrophilic unit derived from (meth)acrylic acid and a hydrophobic unit derived from at least one of a monomer having an aromatic ring and a (meth)acrylate monomer is preferable. In particular, a resin having a hydrophilic unit derived from (meth)acrylic acid and a hydrophobic unit derived from at least one monomer of styrene and α-methylstyrene is preferable. These resins easily cause an interaction with the pigment, and thus can be suitably utilized as resin dispersants for dispersing the pigment.

The hydrophilic unit is a unit having a hydrophilic group such as an anionic group. The hydrophilic unit can be formed by, for example, polymerizing a hydrophilic monomer having a hydrophilic group. Specific examples of the hydrophilic monomer having a hydrophilic group include acidic monomers having a carboxylic acid group, such as (meth)acrylic acid, itaconic acid, maleic acid and fumaric acid; and anionic monomers, such as anhydrides and salts of these acidic monomers. Examples of the cation constituting the salt of the acidic monomer include lithium, sodium, potassium, ammonium and organic ammonium ions. The hydrophobic unit is a unit having no hydrophilic group such as an anionic group. The hydrophobic unit can be formed by, for example, polymerizing the hydrophobic monomer having no hydrophilic group such as anionic group. Specific examples of the hydrophobic monomer include monomers having an aromatic ring, such as styrene, α-methylstyrene and benzyl (meth)acrylate; and (meth)acrylate monomers such as methyl (meth)acrylate, butyl (meth)acrylate and 2-ethylhexyl (meth)acrylate.

The urethane-based resin can be obtained by, for example, reacting polyisocyanate with a polyol. In addition, a chain extender may be further reacted. Examples of the olefinic resin include polyethylene and polypropylene.

The resin in the ink requires to have a functional group (hereinafter, sometimes referred to as “reactive group”) capable of reacting with a functional group (crosslinkable group) in the crosslinking agent. Examples of the functional group (reactive group) in the resin include a hydroxy group, a carboxy group, a thiol group and an amino group. The resin preferably has one or two or more of these functional groups.

### [Properties of Resin]

The phrase “resin is water-soluble” as used herein means that, when the resin is neutralized with an alkali whose amount is equivalent to the acid value, the resin is present in an aqueous medium in a state where the resin does not form any particle whose particle diameter may be measured by Dynamic Light Scattering. Whether or not the resin is water-soluble can be determined according to the method shown below. First, a liquid (resin solid content: 10% by mass) containing a resin neutralized with an alkali (e.g., sodium hydroxide or potassium hydroxide) corresponding to the acid value is prepared. Next, the prepared liquid is diluted ten times with pure water (on a volume basis) to prepare a sample solution.

Then, when no particle having a particle diameter is measured at the time of the measurement of the particle diameter of the resin in the sample solution by Dynamic Light Scattering, the resin can be determined to be water-soluble. At this time, measurement conditions may be set, for example, as follows: Set Zero: 30 seconds, number of times of measurement: three times, and measurement time: 180 seconds. As a particle size distribution measuring apparatus, a particle size analyzer based on the dynamic light scattering method (e.g., trade name “UPA-EX150” manufactured by Nikkiso Co., Ltd.) or the like can be used.

Of course, the particle size distribution measuring apparatus to be used, the measurement conditions and the like are not limited to the above.

The acid value of the water-soluble resin is preferably 100 mgKOH/g or more to 250 mgKOH/g or less. As used herein, a value measured by a potentiometric titration apparatus using a potassium hydroxide-ethanol titration liquid can be taken as the acid value of the resin. The weight-average molecular weight of the water-soluble resin is preferably 3,000 or more to 15,000 or less. As used herein, the weight-average molecular weight of the resin can be measured as a value in terms of standard polystyrene measured by gel permeation chromatography (GPC).

The acid value of the resin constituting the resin particle is preferably 5 mgKOH/g or more to 100 mgKOH/g or less. The weight-average molecular weight of the resin constituting the resin particle is preferably 1,000 or more to 2,000,000 or less. The cumulative 50% particle diameter in volume basis (D₅₀) of the resin particle measured by Dynamic Light Scattering is preferably 50 nm or more to 500 nm or less. The cumulative 50% particle diameter in volume basis of the resin particle is the diameter of the particle at which the volume of the particle integrated from the small particle diameter side reaches 50% with respect to the total volume of the measured particle in a particle diameter cumulative curve. The cumulative 50% particle diameter in volume basis of the resin particle can be measured using the aforementioned particle size analyzer of Dynamic Light Scattering and measurement conditions. The resin particle is not required to encompass the coloring material.

### (Aqueous Medium)

The ink is an aqueous ink including at least water as an aqueous medium. An aqueous medium that is water or a mixed solvent of water and a water-soluble organic solvent may be incorporated into the ink. Deionized water or ion-exchanged water is preferably used as water. The content (% by mass) of water in the aqueous ink is preferably 50.0% by mass or more to 95.0% by mass or less, based on the total mass of the ink. The content (% by mass) of the water-soluble organic solvent in the aqueous ink is preferably 2.0% by mass or more to 40.0% by mass or less, based on the total mass of the ink. As the water-soluble organic solvent, a solvent capable of being used in an ink for ink jet, such as an alcohol, (poly)alkylene glycol, glycol ether, a nitrogen-containing solvent or a sulfur-containing solvent can be used. The water-soluble organic solvent may be used alone, or two or more may be used in combination.

### (Other Components)

The ink may contain various other components, if necessary. Examples of other components include various additives such as a defoaming agent, a surfactant, a pH adjustor, a viscosity modifier, an anticorrosive, an antiseptic, a fungicide, an antioxidant and an anti-reducing agent. However, the ink preferably contains no reactant to be incorporated into the reaction liquid. Also, the ink preferably contains no crosslinking agent to be incorporated into the reaction liquid.

### (Physical Properties of Ink)

The ink is an aqueous ink to be applied to an ink jet system. Therefore, the physical property value thereof is preferably suitably controlled, from the viewpoint of reliability. Specifically, the surface tension of the ink at 25° C. is preferably 20 mN/m or more to 60 mN/m or less. The viscosity of the ink at 25° C. is preferably 1.0 mPa·s or more to 10.0 mPa·s or less. The pH of the ink at 25° C. is preferably 7.0 or more to 9.5 or less, and more preferably 8.0 or more to 9.5 or less.

### <Ink Jet Recording Method and Ink Jet Recording Apparatus>

The ink jet recording method of the present disclosure (hereinafter, simply referred to as “recording method”) is a method for recording an image on a recording medium by using an aqueous ink, and an aqueous reaction liquid containing a reactant reacting with the aqueous ink. The recording method includes a step of applying the reaction liquid to the recording medium, and a step of applying the aqueous ink to the recording medium by ejecting the aqueous ink from an ejection head of an ink jet system so that the aqueous ink overlaps at least a part of a region of the recording medium to which the reaction liquid is applied.

The ink jet recording apparatus of the present disclosure (hereinafter, simply referred to as “recording apparatus”) is an apparatus used for an ink jet recording method for recording an image on a recording medium by using an aqueous ink, and an aqueous reaction liquid containing a reactant reacting with the aqueous ink. The recording apparatus includes a reaction liquid applying unit for applying the reaction liquid to the recording medium, and an ink applying unit for applying the aqueous ink to the recording medium by ejecting the aqueous ink from an ejection head of an ink jet system so that the aqueous ink overlaps at least a part of a region of the recording medium to which the reaction liquid is applied. The recording apparatus is preferably used for the ink jet recording method of the present disclosure.

The aqueous ink used in the above recording method and recording apparatus contains a resin. The reaction liquid used in the recording method and recording apparatus contains at least one reactant selected from the group consisting of a polyvalent metal salt and a cationic resin; an ionic surfactant; and a crosslinking agent capable of forming a bond with the resin in the aqueous ink. As the ink and reaction liquid used in the present recording method and recording apparatus, the aforementioned ink and reaction liquid are suitable, and the aforementioned ink set containing the aforementioned ink and reaction liquid is preferably used.

### (Ink Jet Recording Apparatus)

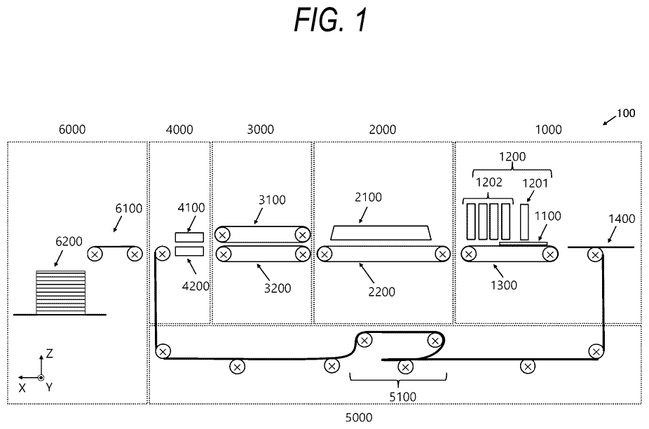

Hereinafter, the details of the ink jet recording apparatus will be described with reference to the drawings. FIG. 1 is a schematic diagram illustrating an example of a schematic configuration of the ink jet recording apparatus. The ink jet recording apparatus of the present embodiment is an ink jet recording apparatus for recording an image on a recording medium using a reactant reacting with an ink, and the ink. An X-direction, a Y-direction and a Z-direction respectively represent the width direction (total length direction), depth direction and height direction of the ink jet recording apparatus. The recording medium is conveyed in the X direction.

An ink jet recording apparatus 100 of the embodiment illustrated in FIG. 1 is configured to include a recording section 1000, a heating section 2000, a fixing section 3000, a cooling section 4000, a reversing section 5000 and a paper delivery section 6000. In the recording section 1000, various liquids are applied to a recording medium 1100, which is conveyed from a paper feeding apparatus 1400 by a conveying member 1300, by a liquid applying device 1200. In the heating section 2000, the liquids applied to the recording medium 1100 are heated by a heating apparatus 2100, thereby evaporating volatile components in the liquids, such as moisture, for drying. In the fixing section 3000, a fixing member 3100 is brought into contact with a region of the recording medium 1100 to which the liquid is applied and heated to accelerate the fixation of an image to the recording medium 1100. Thereafter, the recording medium 1100 is cooled by a cooling member 4100 in the cooling section 4000. When an image is recorded on the rear surface subsequently to the front surface (recording surface), first, the recording medium 1100 is reversed by a reversing apparatus 5100 in the reversing section 5000. Then, after an image is recorded on the rear surface as in the case of the front surface, the recording medium is conveyed by a conveying member 6100 in the paper delivery section 6000 and is loaded and stored on a recording medium storage section 6200. Here, a configuration having a heating section 2000, a fixing section 3000, a cooling section 4000 and a reversing section 5000 is described as an example. However, the heating section, the fixing section, the cooling section and the reversing section may be omitted depending on the recording conditions (such as the type of ink and recording medium, and the recording speed).

Any recording medium may be used as the recording medium 1100. A recording medium having ink absorbability (permeability), for example, a recording medium having no coating layer, such as plain paper or uncoated paper, or a recording medium having a coating layer, such as glossy paper or art paper, can be used. Also, a recording medium having no permeability, such as a film or sheet formed from a resin material such as polyvinyl chloride (PVC) or polyethylene terephthalate (PET) can be used.

### [Recording Section]

The recording section 1000 has the liquid applying device 1200. The liquid applying device 1200 is configured to include a reaction liquid applying device 1201 and an ink applying device 1202. The reaction liquid applying device 1201 illustrated in FIG. 1 is an example of a unit using an ejection head of the ink jet system. In addition, the reaction liquid applying device may be configured by utilizing a gravure coater, an offset coater, a die coater, a blade coater or the like. The application of the reaction liquid by the reaction liquid applying device 1201 may be either before or after the application of the ink, as long as the reaction liquid can be brought into contact with the ink on the recording medium 1100. However, to record a high-quality image on various recording media having different liquid-absorbing characteristics, the reaction liquid is preferably applied before the application of the ink. As the ink applying device 1202, the ejection head (recording head) of the ink jet system is used. Examples of the ejection system of the ejection head serving as the liquid applying device 1200 include a system including ejecting a liquid by causing film boiling in the liquid with an electro-thermal converter to form bubbles, and a system including ejecting the liquid with an electro-mechanical converter.

The liquid applying device 1200 is a line head extended in the Y-direction, and ejection orifices are arranged in a range covering the image recording region of the recording medium having the maximum usable width. The ejection head has an ejection orifice surface (not shown) having an ejection orifice formed on a lower part of the ejection head (recording medium 1100 side), and the ejection orifice surface faces the recording medium 1100 with a fine distance of about several millimeters.

A plurality of ink applying devices 1202 may be provided to apply inks of respective colors to the recording medium 1100. For example, when respective color images are recorded using a yellow ink, a magenta ink, a cyan ink and a black ink, four ink applying devices 1202 that eject the above four kinds of inks are arranged in a line in the X direction. Hereinafter, the ink and the reaction liquid are sometimes collectively referred to as “liquids”.

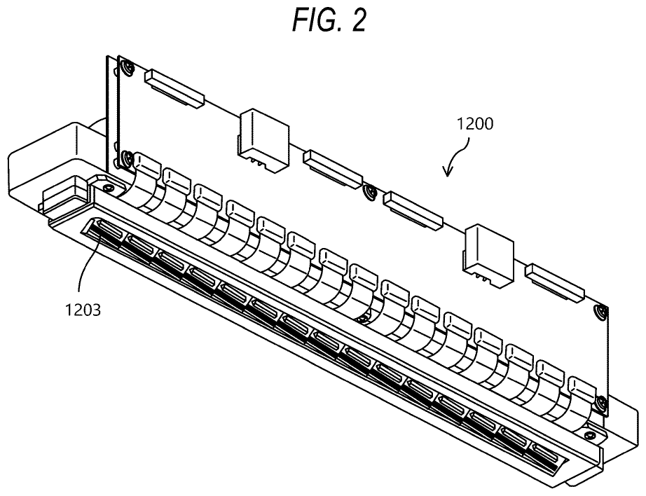

FIG. 2 is a perspective view of an example of the liquid applying device. The liquid applying device 1200 illustrated in FIG. 2 is an example of a line head. In the liquid applying device 1200 serving as a line head, a plurality of ejection element substrates 1203 provided with ejection orifice arrays are linearly arranged. A plurality of ejection orifice arrays are arranged in the ejection element substrate 1203.

### [Conveyance System]

As illustrated in FIG. 1, the recording section 1000 is configured to include the liquid applying device 1200 and the conveying member 1300 that conveys the recording medium 1100. The reaction liquid and the ink are applied to desired positions of the recording medium 1100 that is conveyed by the conveying member 1300, by the liquid applying device 1200. The respective liquid applying devices receive the image signals of recorded data to apply the required reaction liquid and ink to respective positions. FIG. 1 illustrates the conveying member 1300 in the form of a conveying belt. A spur or a conveying cylinder may be utilized, as long as the spur or the conveying cylinder has a function of conveying the recording medium 1100. To enhance conveyance accuracy, a member capable of fixing the recording medium 1100 can be used as the conveying member 1300. Specific examples thereof include an approach including providing holes in the conveying member 1300 and sucking the recording medium 1100 from the rear surface side thereof to fix the recording medium 1100, and an approach including forming the conveying member 1300 from an appropriate material and electrostatically adsorbing the recording medium 1100 to fix the recording medium 1100.

### [Heating Section]

As illustrated in FIG. 1, the heating section 2000 is configured to include the heating apparatus 2100 and a conveying member 2200. The recording medium 1100 to which the reaction liquid and the ink are applied and on which an image is recorded, is heated by the heating apparatus 2100 while being conveyed by the conveying member 2200. Thus, the liquid components of the image are evaporated and dried. A drying step by heating the recording medium to which the ink is applied in a non-contact manner and thereby drying the ink is further preferably included between the ink applying step and a fixing step. Having such a drying step enables the deformation (cockling or curl) of the recording medium 1100 to be effectively suppressed.

The heating apparatus 2100 may have any configuration, as long as the recording medium 1100 can be heated, and conventionally known various apparatuses such as a warm-air drier and a heater can be used. Above all, a non-contact heater such as an electric heating wire and an infrared heater is preferably utilized in terms of safety and energy efficiency. In addition, in the case of utilizing a mechanism in which a fan is built to inject heated gas to the recording medium 1100 and warm air is blown, drying efficiency is easily enhanced.

As for the heating method, the recording medium 1100 may be heated from the surface (recording surface (front surface)) side to which the reaction liquid and the ink are applied, may be heated from the rear surface side, or may be heated from both surfaces. A heating function may be imparted to the conveying member 2200. FIG. 1 illustrates the conveying member 2200 utilizing a conveying belt. A spur or a conveying cylinder may be utilized, as long as the spur or the conveying cylinder has a function of conveying the recording medium 1100. From the viewpoint of suppressing the deformation of the recording medium 1100 by the heating, a configuration in which the recording medium 1100 is conveyed while bringing the recording medium 1100 into close contact with the conveying member 2200 by blowing air from the heating section 2000, or providing a mechanism that fixes the recording medium on the conveying member 2200 is preferable. Specific examples thereof include an approach including providing holes in the conveying member 2200 and sucking the recording medium 1100 from the rear surface side thereof to fix the recording medium 1100, and an approach including forming the conveying member 2200 from an appropriate material and electrostatically adsorbing the recording medium 1100 to fix the recording medium 1100.

A heating temperature is preferably set so that the liquid component may be quickly evaporated, and the recording medium 1100 may not be overdried from the viewpoint of suppressing the deformation of the recording medium 1100. Considering the conveying speed and the environmental temperature, the temperature of a drying unit may be set so that the recording medium may have a desired temperature. Specifically, the temperature of the drying unit (e.g., warm air) is preferably set to 40° C. or more to 100° C. or less, and more preferably 60° C. or more to 80° C. or less. In addition, when heated air is blown to heat the recording medium 1100, the air speed is preferably set to 1 m/s or more to 100 m/s or less. The temperature of air such as warm air can be measured using a K-type thermocouple thermometer. Specific examples of a measuring machine include trade name “AD-5605H” (manufactured by A&D Company, Limited).

### [Fixing Section]

As illustrated in FIG. 1, the fixing section 3000 is a contact-type heating and pressurizing mechanism including the fixing member 3100 serving as a fixing belt such as an endless belt, and the conveying member 3200. In the fixing section 3000, the recording medium 1100 is conveyed by the conveying member 3200, the fixing member 3100 is brought into contact with the recording medium 1100 in a pressurized state to heat the liquids applied to the recording medium 1100, such as the reaction liquid and the ink. Consequently, an image can be fixed to the recording medium 1100. The liquid components of the reaction liquid and the ink are permeated into the recording medium 1100 or evaporated by being passed through the heating section 2000 from the recording medium 1100 on which an image is recorded. Thereafter, the reaction liquid and the ink are fixed in the fixing section 3000, so that an image is completed. When the recording medium 1100 is heated and pressurized in a state of being sandwiched between the fixing member 3100 and the conveying member 3200, the image on the recording medium 1100 and the fixing member 3100 are brought into close contact with each other, so that the image is fixed on the recording medium 1100. When a liquid such as an ink that contains the resin particle and a coloring material is used, the resin particle is softened through heating mainly by the fixing section 3000 to form a film, so that the coloring material can be bound onto the recording medium 1100.

Examples of a method of heating the fixing member 3100 include a system including providing a heat source such as a halogen heater in each of the rollers that drive the fixing member 3100 serving as a fixing belt to heat the fixing member 3100. Examples thereof also include a system including providing a heat source such as an infrared heater at a position different from the fixing member 3100 to heat the fixing member 3100. Further, these systems may be combined with each other. The conveying member 3200 may be heated, if necessary. Considering the conveying speed and the environmental temperature, the temperature of the fixing member 3100 may be set so that the surface of the recording medium may have a desired temperature. Specifically, the temperature of the fixing member 3100 is preferably set to 50° C. or more to 120° C. or less, and more preferably 60° C. or more to 110° C. or less. Each of the temperature of the contact-type heating and pressurizing mechanism (fixing member 3100) and the surface temperature of the recording medium immediately after being passed through the contact-type heating and pressurizing mechanism can be measured by a radiation thermometer. The radiation thermometer may be installed near an end part (terminal) of the contact-type heating and pressurizing mechanism. Specific examples of the radiation thermometer include trade name “RADIATION THERMOMETER IT-545S” (manufactured by Horiba, Ltd.).

### [Cooling Section]

The cooling section 4000 is configured to include the cooling member 4100 and a conveying member 4200 (FIG. 1). The cooling section 4000 cools the recording medium 1100 that has passed through the heating section 2000 and the fixing section 3000 to have a high temperature. The cooling member 4100 may have any configuration as long as the recording medium 1100 can be cooled. An approach such as air cooling and cooling with water can be utilized. Above all, blowing gas that is not heated is preferable in terms of safety and energy efficiency. In addition, in the case of utilizing a mechanism in which a fan is built to inject gas on the recording medium 1100 and air is blown, cooling efficiency is easily enhanced. Considering the conveying speed and the environmental temperature, the temperature of a cooling unit may be set so that the image on the recording medium may have a desired temperature. Specifically, the temperature of the cooling unit (blowing air) is preferably set to 20° C. or more to 60° C. or less, and more preferably 25° C. or more to 50° C. or less. In the case of blowing gas for cooling, the air speed is preferably set to 1 m/s or more to 100 m/s or less. Having such conditions enables the deformation of the recording medium 1100 to be loaded on the paper delivery section 6000 described below and the sticking (blocking) of the image to be suppressed.

### [Reversing Section]

When double-sided recording is performed, the recording medium 1100 is reversed by utilizing the reversing section 5000 (FIG. 1). The recording medium 1100 in which an image is recorded on the recording surface (front surface) thereof passes through the cooling section 4000, then diverged and conveyed, and reversed by the reversing apparatus 5100. The reversed recording medium 1100 is conveyed to the paper feeding apparatus 1400 of the recording section 1000 in a state where the liquids are applied to the rear surface (surface opposite to the recording surface (front surface)) thereof.

### [Paper Delivery Section]

The recording medium 1100 after the image recording is stored in the paper delivery section 6000 (FIG. 1). The recording medium 1100 that has passed through the cooling section 4000 after single-sided recording or double-sided recording is conveyed by the conveying member 6100 and is finally stored in a state of being loaded on the recording medium storage section 6200. Two or more recording medium storage sections 6200 may be provided, for example, to separately store different recorded matters.

### (Reaction Liquid Applying Step)

The reaction liquid applying step is a step of applying the reaction liquid containing the reactant capable of reacting with the ink to the recording medium. As mentioned above, as a reaction liquid applying unit, any of coating apparatuses such as various coaters can be used to apply the reaction liquid to the recording medium. The reaction liquid is preferably ejected from the ejection head (recording head) of the ink jet system and applied to the recording medium. When the ejection head of the ink jet system is used to apply the reaction liquid to the recording medium, the amount of the reaction liquid to be ejected can be finely adjusted. When the reaction liquid is applied using the ejection head, the reaction liquid can be controlled so as not to be applied to a margin portion on which no ink is applied in the recording medium, and the reactant hardly remains on the surface of the margin portion. Thus, when the reactant remains on the surface of the margin portion, the remaining reactant can be suppressed from scratching the image layer, so that the abrasion resistance of an image can be further improved.

### (Ink Applying Step)

An ink applying step is a step of applying the aqueous ink to the recording medium by ejecting the aqueous ink from an ejection head of an ink jet system so that the aqueous ink overlaps at least a part of a region of the recording medium to which the reaction liquid is applied. The step enables the functional group in the resin in the ink, such as a carboxy group, and the functional group in the crosslinking agent in the reaction liquid, such as a carbodiimide group or an oxazoline group, to be reacted with each other. Accordingly, a crosslinking structure can be formed in an image layer that is formed from the ink and the reaction liquid, and fastness such as abrasion resistance and water abrasion resistance of the image to be recorded can be improved. As mentioned above, as an ink applying unit, the ejection head (recording head) of the ink jet system is used to apply the ink to the recording medium. As mentioned above, the application of the ink to the recording medium is preferably performed after the reaction liquid is applied to the recording medium.

### (Drying Step)

The aforementioned recording method preferably includes a drying step of subjecting the recording medium to which the reaction liquid and the ink are applied to drying by a heating system. When the above drying step is performed after the step of applying the reaction liquid and the ink to the recording medium, the aqueous medium of the image layer is evaporated to reduce the remaining component in the image layer as much as possible, so that abrasion resistance can be further improved. In addition, the resin particle is allowed to form a film by heating, so that the strength of the image layer is improved and abrasion resistance can be further improved.

### (Composition of Image Layer)

Examples of the solid content remained in the image layer obtained by applying the reaction liquid and the ink to the recording medium 1100 by a recording section 1200 of the above-described ink jet recording apparatus 100, and, if necessary, drying by the heating section 2000 include a polyvalent metal salt, a crosslinking agent, a coloring material and a resin. Among them, examples of the factor that significantly influences on the fastness such as abrasion resistance and water abrasion resistance of an image include the amount of the resin and the amount of the crosslinking agent. The following relationship is preferably satisfied where, in the image layer, E denotes an amount of functional groups (amount of crosslinkable groups, μmol/m²) in the crosslinking agent, and D denotes an amount of functional groups (amount of reactive groups, μmol/m²) in the resin per unit area of the recording medium. That is, from the viewpoint of further easily improving the abrasion resistance and water abrasion resistance of an image, D/E is preferably 0.5 or more to 6.0 or less in the image layer formed from the reaction liquid and the aqueous ink applied to the recording medium. E denotes an amount (μmol/m²) of crosslinkable groups in the crosslinking agent in the reaction liquid and D denotes an amount (μmol/m²) of reactive groups in the resin in the ink per unit area of the recording medium can be calculated as follows. First, based on the value (%) of the recording duty and its definition, the amount (g/m²) of the reaction liquid and the ink applied per unit area of the recording medium are calculated. Next, based on the content (% by mass) of the crosslinking agent in the reaction liquid and the content (% by mass) of the resin (resin particle) in the ink, the amount (g/m²) of the crosslinking agent and the resin particle applied per unit area of the recording medium can be calculated. Consequently, based on the calculated amount (g/m²) of the crosslinking agent and the crosslinkable group equivalent (carbodiimide group equivalent, epoxy group equivalent, oxazoline group equivalent or the like) of the crosslink agent, the amount of the crosslinkable group E (μmol/m²) per unit area of the recording medium can be calculated. Similarly, based on the calculated amount (g/m²) of the resin particle and the amount of the reactive group (carboxy group equivalent (μmol/g) or the like) of the resin particle, the amount of the reactive group D (μmol/m²) per unit area of the recording medium can be calculated. In Examples described below, D/E values were calculated using D and E calculated as above.

### EXAMPLES

Hereinafter, the present disclosure will be described further in detail with reference to Examples and Comparative Examples, but the present disclosure is not limited to Examples below in any way without departing from the gist thereof. Unless otherwise specified, “parts” and “%” described with respect to the amount of components are based on the mass.

### <Preparation of Reaction Liquid>

Respective components (unit: %) shown in the upper columns in Table 1 (Table 1-1 to Table 1-3) were mixed, sufficiently stirred, and then filtered through a cellulose acetate filter having a pore size of 3.0 μm (manufactured by ADVANTEC CO., LTD.) under pressure to prepare each reaction liquid. In the lower columns in Table 1, the content A (%) of the reactant, the content B (%) of the crosslinking agent and the content C (%) of the ionic surfactant in the reaction liquid, and a value of (A+B)/C were shown as the characteristics of the reaction liquid. The amounts of the hydrates of polyvalent metal salts shown in the upper columns in Table 1 are amounts in terms of polyvalent metal salt. The amounts of the cationic resin and crosslinking agents are amounts in terms of solid content as an active ingredient. Further, the amount of water contained in the hydrates of polyvalent metal salts and the amount of water contained in the cationic resin product and the crosslinking agent products are included in the amount of the ion-exchange water.

The details of the materials used in the preparation of the reaction liquid shown in Table 1 are as follows.

### (Reactant)

Magnesium sulfate 7-hydrate (solubility in water at 25° C.: 25 g/100 g)
Calcium chloride 2-hydrate (solubility in water at 25° C.: 74.5 g/100 g)
Calcium nitrate 4-hydrate (solubility in water at 25° C.: 121.2 g/100 g)
Calcium sulfate 2-hydrate (solubility in water at 25° C.: 0.21 g/100 g)
PAS-H-5L: trade name of a cationic resin manufactured by NITTOBO MEDICAL CO., LTD. (solid content: 28%)

### (Surfactant)

Acetylenol E100: trade name of a nonionic surfactant manufactured by Kawaken Fine Chemicals Co., Ltd. (acetylene glycol ethylene oxide adduct)
NISSAN CATION EQ-01D: trade name of a cationic surfactant manufactured by NOF CORPORATION (dicocoylethyl hydroxyethylmonium methosulfate)
Sodium 2-ethylhexyl sulfate: an anionic surfactant
AMPHITOL 20HD: trade name of an amphoteric surfactant manufactured by Kao Corporation (laurylhydoxysulfo betaine)

### (Crosslinking Agent)

CARBODILITE SV-02: trade name of a carbodiimide crosslinking agent having two or more carbodiimide groups for aqueous resin manufactured by Nisshinbo Chemical Inc. (solid content: 40%, crosslinkable group (carbodiimide group) equivalent: 430)
DENACOL EX-313: trade name of an epoxy crosslinking agent having two or more epoxy groups manufactured by Nagase ChemteX Corporation. (solid content: 100%, crosslinkable group (epoxy group) equivalent: 141)
EPOCROS WS-300: trade name of an oxazoline group-containing water-soluble polymer having two or more oxazoline groups manufactured by NIPPON SHOKUBAI CO., LTD. (solid content: 10%, crosslinkable group (oxazoline group) equivalent: 130)
ELASTRON BN-69: trade name of an aqueous polyisocyanate crosslinking agent having two or more isocyanate groups manufactured by DKS Co. Ltd. (solid content: 40%, crosslinkable group (isocyanate group) equivalent: unknown)
CARBODILITE V-02: trade name of a carbodiimide crosslinking agent having two or more carbodiimide groups for aqueous resin manufactured by Nisshinbo Chemical Inc. (solid content: 40%, crosslinkable group (carbodiimide group) equivalent: 590)
(The above crosslinkable group equivalent means the chemical formula weight per 1 mol of the crosslinkable group.)

TABLE 1-1
(Composition and characteristics of reaction liquid)

| | Reaction liquid | | | | | | | |
|---|---|---|---|---|---|---|---|---|
| | 1 | 2 | 3 | 4 | 5 | 6 | 7 | 8 |
| Acetylenol E100 | 0.5 | 0.5 | 0.5 | 0.5 | 0.5 | 0.5 | 0.5 | 0.5 |
| NISSAN CATION EQ-01D | 1.0 | 1.0 | 0.0 | 0.0 | 1.0 | 1.0 | 1.0 | 1.0 |
| Sodium 2-ethylhexyl sulfate | 0.0 | 0.0 | 1.0 | 0.0 | 0.0 | 0.0 | 0.0 | 0.0 |
| AMPHITOL 20HD | 0.0 | 0.0 | 0.0 | 1.0 | 0.0 | 0.0 | 0.0 | 0.0 |
| Magnesium sulfate 7-hydrate | 5.0 | 0.0 | 5.0 | 5.0 | 0.0 | 0.0 | 0.0 | 0.0 |
| Calcium chloride 2-hydrate | 0.0 | 0.0 | 0.0 | 0.0 | 5.0 | 0.0 | 0.0 | 0.0 |
| Calcium phosphate | 0.0 | 0.0 | 0.0 | 0.0 | 0.0 | 5.0 | 0.0 | 0.0 |
| Calcium nitrate 4-hydrate | 0.0 | 0.0 | 0.0 | 0.0 | 0.0 | 0.0 | 5.0 | 0.0 |
| Calcium sulfate 2-hydrate | 0.0 | 0.0 | 0.0 | 0.0 | 0.0 | 0.0 | 0.0 | 5.0 |
| PAS-H-5L | 0.0 | 5.0 | 0.0 | 0.0 | 0.0 | 0.0 | 0.0 | 0.0 |
| Lactic acid | 0.0 | 0.0 | 0.0 | 0.0 | 0.0 | 0.0 | 0.0 | 0.0 |
| CARBODILITE SV-02 | 10.0 | 10.0 | 10.0 | 10.0 | 10.0 | 10.0 | 10.0 | 10.0 |
| DENACOL EX-313 | 0.0 | 0.0 | 0.0 | 0.0 | 0.0 | 0.0 | 0.0 | 0.0 |
| EPOCROS WS-300 | 0.0 | 0.0 | 0.0 | 0.0 | 0.0 | 0.0 | 0.0 | 0.0 |
| ELASTRON BN-69 | 0.0 | 0.0 | 0.0 | 0.0 | 0.0 | 0.0 | 0.0 | 0.0 |
| CARBODILITE V-02 | 0.0 | 0.0 | 0.0 | 0.0 | 0.0 | 0.0 | 0.0 | 0.0 |
| 1,2-Propanediol (boiling point 188° C.) | 10.0 | 10.0 | 10.0 | 10.0 | 10.0 | 10.0 | 10.0 | 10.0 |
| Glycerin (boiling point 290° C.) | 0.0 | 0.0 | 0.0 | 0.0 | 0.0 | 0.0 | 0.0 | 0.0 |
| Ion-exchange water | 73.5 | 73.5 | 73.5 | 73.5 | 73.5 | 73.5 | 73.5 | 73.5 |
| Content A (%) of reactant | 5.0 | 5.0 | 5.0 | 5.0 | 5.0 | 5.0 | 5.0 | 5.0 |
| Content B (%) of crosslinking agent | 10.0 | 10.0 | 10.0 | 10.0 | 10.0 | 10.0 | 10.0 | 10.0 |
| Content C (%) of ionic surfactant | 1.0 | 1.0 | 1.0 | 1.0 | 1.0 | 1.0 | 1.0 | 1.0 |
| Value of (A + B)/C | 15.0 | 15.0 | 15.0 | 15.0 | 15.0 | 15.0 | 15.0 | 15.0 |

TABLE 1-2
(Composition and characteristics of reaction liquid)

| | Reaction liquid | | | | | | |
|---|---|---|---|---|---|---|---|
| | 9 | 10 | 11 | 12 | 13 | 14 | 15 |
| Acetylenol E100 | 0.5 | 0.5 | 0.5 | 0.5 | 0.5 | 0.5 | 0.5 |
| NISSAN CATION EQ-01D | 1.0 | 1.0 | 1.0 | 1.0 | 1.0 | 1.0 | 1.0 |
| Sodium 2-ethylhexyl sulfate | 0.0 | 0.0 | 0.0 | 0.0 | 0.0 | 0.0 | 0.0 |
| AMPHITOL 20HD | 0.0 | 0.0 | 0.0 | 0.0 | 0.0 | 0.0 | 0.0 |
| Magnesium sulfate 7-hydrate | 5.0 | 5.0 | 5.0 | 5.0 | 5.0 | 1.0 | 31.0 |
| Calcium chloride 2-hydrate | 0.0 | 0.0 | 0.0 | 0.0 | 0.0 | 0.0 | 0.0 |
| Calcium phosphate | 0.0 | 0.0 | 0.0 | 0.0 | 0.0 | 0.0 | 0.0 |
| Calcium nitrate 4-hydrate | 0.0 | 0.0 | 0.0 | 0.0 | 0.0 | 0.0 | 0.0 |
| Calcium sulfate 2-hydrate | 0.0 | 0.0 | 0.0 | 0.0 | 0.0 | 0.0 | 0.0 |
| PAS-H-5L | 0.0 | 0.0 | 0.0 | 0.0 | 0.0 | 0.0 | 0.0 |
| Lactic acid | 0.0 | 0.0 | 0.0 | 0.0 | 0.0 | 0.0 | 0.0 |
| CARBODILITE SV-02 | 10.0 | 0.0 | 0.0 | 0.0 | 0.0 | 10.0 | 10.0 |
| DENACOL EX-313 | 0.0 | 10.0 | 0.0 | 0.0 | 0.0 | 0.0 | 0.0 |
| EPOCROS WS-300 | 0.0 | 0.0 | 10.0 | 0.0 | 0.0 | 0.0 | 0.0 |
| ELASTRON BN-69 | 0.0 | 0.0 | 0.0 | 10.0 | 0.0 | 0.0 | 0.0 |
| CARBODILITE V-02 | 0.0 | 0.0 | 0.0 | 0.0 | 10.0 | 0.0 | 0.0 |
| 1,2-Propanediol (boiling point 188° C.) | 0.0 | 10.0 | 10.0 | 10.0 | 10.0 | 10.0 | 10.0 |
| Glycerin (boiling point 290° C.) | 10.0 | 0.0 | 0.0 | 0.0 | 0.0 | 0.0 | 0.0 |
| Ion-exchange water | 73.5 | 73.5 | 73.5 | 73.5 | 73.5 | 77.5 | 47.5 |
| Content A (%) of reactant | 5.0 | 5.0 | 5.0 | 5.0 | 5.0 | 1.0 | 31.0 |
| Content B (%) of crosslinking agent | 10.0 | 10.0 | 10.0 | 10.0 | 10.0 | 10.0 | 10.0 |
| Content C (%) of ionic surfactant | 1.0 | 1.0 | 1.0 | 1.0 | 1.0 | 1.0 | 1.0 |
| Value of (A + B)/C | 15.0 | 15.0 | 15.0 | 15.0 | 15.0 | 11.0 | 41.0 |

TABLE 1-3
(Composition and characteristics of reaction liquid)

| | Reaction liquid | | | | | | |
|---|---|---|---|---|---|---|---|
| | 16 | 17 | 18 | 19 | 20 | 21 | 22 |
| Acetylenol E100 | 0.5 | 0.5 | 0.5 | 0.5 | 1.5 | 0.5 | 0.5 |
| NISSAN CATION EQ-01D | 1.0 | 1.0 | 3.75 | 1.0 | 0.0 | 1.0 | 1.0 |
| Sodium 2-ethylhexyl sulfate | 0.0 | 0.0 | 0.0 | 0.0 | 0.0 | 0.0 | 0.0 |
| AMPHITOL 20HD | 0.0 | 0.0 | 0.0 | 0.0 | 0.0 | 0.0 | 0.0 |
| Magnesium sulfate 7-hydrate | 5.0 | 5.0 | 5.0 | 17.0 | 5.0 | 0.0 | 5.0 |
| Calcium chloride 2-hydrate | 0.0 | 0.0 | 0.0 | 0.0 | 0.0 | 0.0 | 0.0 |
| Calcium phosphate | 0.0 | 0.0 | 0.0 | 0.0 | 0.0 | 0.0 | 0.0 |
| Calcium nitrate 4-hydrate | 0.0 | 0.0 | 0.0 | 0.0 | 0.0 | 0.0 | 0.0 |
| Calcium sulfate 2-hydrate | 0.0 | 0.0 | 0.0 | 0.0 | 0.0 | 0.0 | 0.0 |
| PAS-H-5L | 0.0 | 0.0 | 0.0 | 0.0 | 0.0 | 0.0 | 0.0 |
| Lactic acid | 0.0 | 0.0 | 0.0 | 0.0 | 0.0 | 5.0 | 0.0 |
| CARBODILITE SV-02 | 1.0 | 21.0 | 10.0 | 34.0 | 10.0 | 10.0 | 0.0 |
| DENACOL EX-313 | 0.0 | 0.0 | 0.0 | 0.0 | 0.0 | 0.0 | 0.0 |
| EPOCROS WS-300 | 0.0 | 0.0 | 0.0 | 0.0 | 0.0 | 0.0 | 0.0 |
| ELASTRON BN-69 | 0.0 | 0.0 | 0.0 | 0.0 | 0.0 | 0.0 | 0.0 |
| CARBODILITE V-02 | 0.0 | 0.0 | 0.0 | 0.0 | 0.0 | 0.0 | 0.0 |
| 1,2-Propanediol (boiling point 188° C.) | 10.0 | 10.0 | 10.0 | 10.0 | 10.0 | 10.0 | 10.0 |
| Glycerin (boiling point 290° C.) | 0.0 | 0.0 | 0.0 | 0.0 | 0.0 | 0.0 | 0.0 |
| Ion-exchange water | 82.5 | 62.5 | 70.75 | 37.5 | 73.5 | 73.5 | 83.5 |
| Content A (%) of reactant | 5.0 | 5.0 | 5.0 | 17.0 | 5.0 | 5.0 | 5.0 |
| Content B (%) of crosslinking agent | 1.0 | 21.0 | 10.0 | 34.0 | 10.0 | 10.0 | 0.0 |
| Content C (%) of ionic surfactant | 1.0 | 1.0 | 3.75 | 1.0 | 0.0 | 1.0 | 1.0 |
| Value of (A + B)/C | 6.0 | 26.0 | 4.0 | 51.0 | — | 15.0 | 5.0 |

### <Preparation of Pigment Dispersion Liquid>

### (Pigment Dispersion Liquid 1)

A styrene-ethyl acrylate-acrylic acid copolymer (resin 1 having a carboxy group) having an acid value of 150 mgKOH/g and a weight-average molecular weight of 8,000 was prepared. 20.0 parts of the resin 1 were neutralized with potassium hydroxide equimolar to the acid value of the resin 1, and then an appropriate amount of pure water was added, whereby an aqueous solution of the resin 1 having a content of the resin (solid content) of 20.0% was prepared. 10.0 parts of a pigment (carbon black), 15.0 parts of the aqueous solution of the resin 1 and 75.0 parts of pure water were mixed to obtain a mixture. The obtained mixture and 200 parts of zirconia beads having a diameter of 0.3 mm were put in a batch type vertical sand mill (manufactured by AIMEX Co., Ltd.) and dispersed for 5 hours while cooling with water. After a coarse particle was removed by centrifugation, the mixture was filtered through a cellulose acetate filter having a pore size of 3.0 μm (manufactured by ADVANTEC CO., LTD.) under pressure to prepare a pigment dispersion liquid 1 having a content of the pigment of 10.0% and a content of the resin dispersant (resin 1) of 3.0%.

### (Pigment Dispersion Liquid 2)

A pigment dispersion liquid 2 having a content of the pigment of 10.0% and a content of the resin dispersant (resin 1) of 3.0% was prepared in the same manner as the above-described pigment dispersion liquid 1, except that the pigment was changed to C. I. Pigment Blue 15:3.

### (Pigment Dispersion Liquid 3)

A pigment dispersion liquid 3 having a content of the pigment of 10.0% and a content of the resin dispersant (resin 1) of 3.0% was prepared in the same manner as the above-described pigment dispersion liquid 1, except that the pigment was changed to C. I. Pigment Red 122.

### (Pigment Dispersion Liquid 4)

A pigment dispersion liquid 4 having a content of the pigment of 10.0% and a content of the resin dispersant (resin 1) of 3.0% was prepared in the same manner as the above-described pigment dispersion liquid 1, except that the pigment was changed to C. I. Pigment Yellow 74.

### <Preparation of Resin Particle>

### (Resin Particle Dispersion Liquid)

0.2 Parts of potassium peroxodisulfate and 74.0 parts of ion-exchange water were mixed to prepare a solution. With respect to the details of the monomer charged (parts), 19.0 parts of ethylmethacrylate (EMA), 5.0 parts of n-butylmethacrylate (nBMA), 1.5 parts of methacrylic acid (MAA) and 0.3 parts of a reactive surfactant were mixed to prepare an emulsified product. As the reactive surfactant, trade name “ADEKA REASOAP ER20” (a nonionic surfactant manufactured by ADEKA CORPORATION, the number of ethylene oxide groups: 20) was used. The emulsified product was added dropwise to the solution in a nitrogen atmosphere over 1 hour, and the mixture was polymerized while stirring at 80° C., and then further stirred for 2 hours. After the reaction mixture was cooled to room temperature, ion-exchange water and an aqueous potassium hydroxide solution were added thereto to obtain a resin particle dispersion liquid in which the content of the resin particle having a carboxy group (carboxylic acid group) is 25.0% and the carboxy group equivalent contained in the resin particle is 300 μmol/g.

### <Preparation of Ink>

Respective components (unit: %) shown in Table 2 were mixed, sufficiently stirred, and then filtered through a cellulose acetate filter having a pore size of 3.0 μm (manufactured by ADVANTEC CO., LTD.) under pressure to prepare each ink. “Joncryl 819” shown in Table 2 is a trade name of an aqueous solution of an acrylic copolymer resin that is a water-soluble resin manufactured by BASF (solid (resin) content: 32.1%). In addition, “Acetylenol E100” is a trade name of a nonionic surfactant manufactured by Kawaken Fine Chemicals Co., Ltd. As “Resin particle” in Table 2, the resin particle by drying the above resin particle dispersion liquid was used.

TABLE 2
(composition of ink)

Ink

| | 1 | 2 | 3 | 4 | 5 |
|---|---|---|---|---|---|
| Pigment dispersion | 10.0 | 0.0 | 0.0 | 0.0 | 10.0 |
| liquid 1 (black) | | | | | |
| Pigment dispersion | 0.0 | 10.0 | 0.0 | 0.0 | 0.0 |
| liquid 2 (cyan) | | | | | |
| Pigment dispersion | 0.0 | 0.0 | 10.0 | 0.0 | 0.0 |
| liquid 3 (magenta) | | | | | |
| Pigment dispersion | 0.0 | 0.0 | 0.0 | 10.0 | 0.0 |
| liquid 4 (yellow) | | | | | |
| Resin particle | 20.0 | 20.0 | 20.0 | 20.0 | 0.0 |
| Joncryl 819 | 0.0 | 0.0 | 0.0 | 0.0 | 20.0 |
| 1,2-Propanediol | 20.0 | 20.0 | 20.0 | 20.0 | 20.0 |
| Acetylenol E100 | 1.0 | 1.0 | 1.0 | 1.0 | 1.0 |
| Ion-exchange water | 49.0 | 49.0 | 49.0 | 49.0 | 49.0 |

### <Evaluation>

The reaction liquid and the ink of types (numbers) shown on the left side of Table 3 were combined to form a set of the ink and the reaction liquid. The reaction liquid and the ink constituting the set were respectively charged in the reaction liquid applying device 1201 and the ink applying device 1202 of the ink jet recording apparatus 100 having a configuration illustrated in FIG. 1. Using the above ink jet recording apparatus 100, a solid image of 5 cm×5 cm was recorded on a recording medium. At this time, the solid image was recorded by taking the recording duty of the reaction liquid as 30% and the recording duty of the ink as 100% in Examples 1 to 23 and Comparative Examples 1 to 3. In Example 25, the solid image was recorded by taking the recording duty of the reaction liquid as 30% and the recording duty of the ink as 50%, Example 26, the solid image was recorded by taking the recording duty of the reaction liquid as 5% and the recording duty of the ink as 100%, and in Example 27, the solid image was recorded by taking the recording duty of the reaction liquid as 4% and the recording duty of the ink as 100%. In the ink jet recording apparatus 100, an image recorded under the conditions where 3.0 ng of a liquid droplet (an ink droplet or a reaction liquid droplet) is applied to a unit region of 1/1200 inch× 1/1200 inch is defined as the recording duty of 100%.

With respect to the recording conditions, in Examples and Comparative Examples other than Example 24, each of the reaction liquid and the ink was applied to the recording medium by being ejected from the ejection head of the ink jet system in the order presented so that the reaction liquid and the ink overlapped each other (shown as “IJ ejection” in Table 3). In Example 24, the reaction liquid was applied to the recording medium with a bar coater (shown as “bar coater” in Table 3), and then the ink was applied to the recording medium by being ejected from the ejection head of the ink jet system. Further, the amounts of the reaction liquid and ink applied to the recording medium were set so as to be the D/E value shown in Table 3. D/E is the ratio of the amount of reactive groups D (μmol/m²) in the resin in the ink to the amount of crosslinkable groups E (μmol/m²) in the crosslinking agent in the reaction liquid per unit area of the recording medium, in the image layer formed from the reaction liquid and ink applied to the recording medium.

In the present example, “5”, “4”, “3” and “2” were determined as the acceptable level, and “1” was determined as the unacceptable level, based on the following evaluation criteria of each item. The evaluation results are shown on the right side of Table 3.

### (Abrasion Resistance)

The reaction liquid and the ink were applied to the recording medium under recording conditions using the aforementioned ink jet recording apparatus 100, and then dried by the heating apparatus 2100 of the ink jet recording apparatus 100 under warm air at 80° C. for 6 minutes to obtain a recorded matter. At this time, fixation by the fixing section 3000 and cooling by the cooling section 4000 were not performed. Thereafter, the obtained recorded matter was allowed to stand under conditions of a temperature of 23° C. and a relative humidity of 50% for 24 hours. As the recording medium, a white polyester film (trade name “PET WH50” manufactured by LINTEC Corporation) was used. The recording medium on which an image was recorded was cut into a rectangular shape with a width of 25 mm and evaluated under the following conditions using an abrasion resistance tester (manufactured by Imoto machinery Co., LTD) that is a Gakushin tester. The cut recording medium was installed on the abrasion stage, and a gakushin test cloth (Kanakin No. 3, manufactured by Japanese Standards Association) was installed on the abrasion element, and a rubbing test was performed 50 times at a load of 500 g.

The abrasion resistance of the image was evaluated according to the evaluation criteria shown below based on the visibility of the base of the recording medium through visual observation (hereinafter, the damage rate of the recording surface) and the presence or absence of the transfer of the image on the gakushin test cloth.

5: No change was found on both the recording surface and the test cloth.

4: No change was found on the recording surface, but the transfer of the image was found on the test cloth.

3: The damage rate of the recording surface was less than about 10%.

2: The damage rate of the recording surface was about 10% or more to about 50% or less.

1: The damage rate of the recording surface was about 51% or more.

### (Water Abrasion Resistance)

A rubbing test was performed in the same manner as the above evaluation method for abrasion resistance, except that 100 μL of pure water was added dropwise to the gakushin test cloth used in the above evaluation method for abrasion resistance for wetting, and then rubbing was performed using the wetted site. Then, the water abrasion resistance of the image was evaluated according to the above evaluation criteria of abrasion resistance.

### (Compatibility)

With respect to respective reaction liquids used in respective Examples and Comparative Examples, the compatibility of the components in the reaction liquid was evaluated.

Specifically, 10 g of the reaction liquid shown in Table 1 was warmed under respective temperature conditions in the evaluation criteria shown below for 2 hours, then stirred for 10 seconds, and allowed to stand still for 10 seconds. Thereafter, the presence or absence of the white turbidity of the reaction liquid was confirmed through visual observation, and the compatibility of the reaction liquid was evaluated depending on the temperature at which white turbidity is started to be caused according to the evaluation criteria shown below.

5: White turbidity was not caused even at 81° C. or more.

4: White turbidity was caused at 61° C. or more to 80° C. or less.

3: White turbidity was caused at 41° C. or more to 60° C. or less.

2: White turbidity was caused at 26° C. or more to 40° C. or less.

1: White turbidity was caused at 25° C. or less.

### (Feathering of Image)

Using the above ink jet recording apparatus 100, a ruled line of 36 points was recorded on the above recording medium (trade name “PET WH50”, manufactured by LINTEC Corporation) at a conveying speed of the recording medium of 40 m/minute to produce a sample for feathering evaluation. The obtained image was dried by the heating apparatus 2100 of the ink jet recording apparatus 100 under warm air at 80° C. for 6 minutes. The sample for feathering evaluation was allowed to stand under conditions of a temperature of 23° C. and a relative humidity of 50% for 24 hours, and then a raggedness value Ra was measured. In the measurement of the raggedness value Ra, a personal image quality evaluation system, Personal IAS (manufactured by Quality Engineering Associates, Inc.) was used. Then, the degree of the feathering of an image was evaluated based on the Ra value according to the following evaluation criteria. In the evaluation, the degree of variation in the ruled line width was measured by the above evaluation system, and a lower Ra value means that the ruled line width is constant and the sample is excellent.

5: Ra was 5.0 or less.

4: Ra was 5.1 or more to 9.0 or less.

3: Ra was 9.1 or more to 13.0 or less.

2: Ra was 13.1 or more to 15.0 or less.

1: Ra was 15.1 or more.

TABLE 3
(Evaluation results)

| | | | | Recording method | | | | | |
|---|---|---|---|---|---|---|---|---|---|
| | | | | Application | | Evaluation results | | | |
| | | Ink set | | method of | | | Water | | |
| | | Reaction | | reaction | | Abrasion | abrasion | | |
| | | liquid | Ink | liquid | D/E | resistance | resistance | Compatibility | Feathering |
| Examples | 1 | 1 | 1 | IJ ejection | 0.9 | 5 | 5 | 4 | 5 |
| | 2 | 2 | 1 | IJ ejection | 0.9 | 5 | 5 | 4 | 5 |
| | 3 | 1 | 2 | IJ ejection | 0.9 | 5 | 5 | 4 | 5 |
| | 4 | 1 | 3 | IJ ejection | 0.9 | 5 | 5 | 4 | 5 |
| | 5 | 1 | 4 | IJ ejection | 0.9 | 5 | 5 | 4 | 5 |
| | 6 | 1 | 5 | IJ ejection | — | 2 | 3 | 4 | 5 |
| | 7 | 3 | 1 | IJ ejection | 0.9 | 5 | 3 | 2 | 5 |
| | 8 | 4 | 1 | IJ ejection | 0.9 | 5 | 3 | 3 | 5 |
| | 9 | 5 | 1 | IJ ejection | 0.9 | 5 | 5 | 2 | 4 |
| | 10 | 6 | 1 | IJ ejection | 0.9 | 4 | 3 | 5 | 4 |
| | 11 | 7 | 1 | IJ ejection | 0.9 | 4 | 3 | 5 | 4 |
| | 12 | 8 | 1 | IJ ejection | 0.9 | 4 | 3 | 2 | 4 |
| | 13 | 9 | 1 | IJ ejection | 0.9 | 2 | 2 | 4 | 5 |
| | 14 | 10 | 1 | IJ ejection | 0.3 | 2 | 3 | 4 | 5 |
| | 15 | 11 | 1 | IJ ejection | 0.3 | 3 | 4 | 4 | 5 |
| | 16 | 12 | 1 | IJ ejection | — | 3 | 4 | 4 | 5 |
| | 17 | 13 | 1 | IJ ejection | 1.2 | 4 | 4 | 4 | 5 |
| | 18 | 14 | 1 | IJ ejection | 0.9 | 5 | 5 | 5 | 2 |
| | 19 | 15 | 1 | IJ ejection | 0.9 | 2 | 2 | 2 | 5 |
| | 20 | 16 | 1 | IJ ejection | 8.6 | 2 | 2 | 5 | 5 |
| | 21 | 17 | 1 | IJ ejection | 0.4 | 3 | 3 | 2 | 2 |
| | 22 | 18 | 1 | IJ ejection | 0.9 | 5 | 3 | 5 | 3 |
| | 23 | 19 | 1 | IJ ejection | 0.3 | 4 | 4 | 2 | 3 |
| | 24 | 1 | 1 | Bar coater | — | 2 | 2 | 4 | 5 |
| | 25 | 1 | 1 | IJ ejection | 0.4 | 3 | 3 | 4 | 5 |
| | 26 | 1 | 1 | IJ ejection | 5.2 | 5 | 5 | 4 | 5 |
| | 27 | 1 | 1 | IJ ejection | 6.5 | 2 | 2 | 2 | 3 |
| Comparative | 1 | 20 | 1 | IJ ejection | 0.9 | 3 | 3 | 1 | 2 |
| Examples | 2 | 21 | 1 | IJ ejection | 0.9 | 2 | 1 | 3 | 5 |
| | 3 | 22 | 1 | IJ ejection | 0 | 1 | 1 | 5 | 5 |

According to the present disclosure, an ink set containing an aqueous ink and a reaction liquid that hardly causes white turbidity due to heat and aging in the reaction liquid and is capable of recording an image having favorable abrasion resistance and water abrasion resistance can be provided. In addition, according to the present disclosure, an ink jet recording method and ink jet recording apparatus capable of using the ink set can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-179615, filed Oct. 15, 2024, and Japanese Patent Application No. 2025-164059, filed Sep. 30, 2025, which are hereby incorporated by reference herein in their entirety.

What is claimed is:

1. An ink set used in an ink jet recording method for recording an image on a recording medium by using an aqueous ink, and an aqueous reaction liquid comprising a reactant reacting with the aqueous ink, the ink set comprising the aqueous ink and the reaction liquid, wherein
the aqueous ink comprises a resin,
the reactant comprises at least one selected from the group consisting of a polyvalent metal salt and a cationic resin, and
the reaction liquid further comprises an ionic surfactant, and a crosslinking agent capable of forming a bond with the resin in the aqueous ink.

2. The ink set according to claim 1, wherein the resin comprises a resin particle.

3. The ink set according to claim 1, wherein the ionic surfactant has at least one cationic hydrophilic moiety.

4. The ink set according to claim 1, wherein the ionic surfactant comprises a cationic surfactant.

5. The ink set according to claim 1, wherein a standard enthalpy of formation of an anion constituting the polyvalent metal salt is −1,000 kJmol⁻¹ or more to −200 kJmol⁻¹ or less.

6. The ink set according to claim 1, wherein the polyvalent metal salt comprises a sulfate ion.

7. The ink set according to claim 1, wherein the polyvalent metal salt is magnesium sulfate.

8. The ink set according to claim 1, wherein the reaction liquid comprises a water-soluble organic solvent having a boiling point of 250° C. or less.

9. The ink set according to claim 1, wherein the crosslinking agent has two or more functional groups selected from the group consisting of a carbodiimide group, an isocyanate group and an oxazoline group.

10. The ink set according to claim 1, wherein the crosslinking agent has two or more carbodiimide groups.

11. The ink set according to claim 10, wherein the crosslinking agent has 1 mol of functional groups per molecular weight of 350 to 550.

12. The ink set according to claim 1, wherein a content (% by mass) of the reactant in the reaction liquid is 2.0% by mass or more to 30.0% by mass or less based on a total mass of the reaction liquid, and
a content (% by mass) of the crosslinking agent in the reaction liquid is 2.0% by mass or more to 20.0% by mass or less based on a total mass of the reaction liquid.

13. The ink set according to claim 1, wherein (A+B)/C is 5.0 or more to 50.0 or less where A denotes a content (% by mass) of the reactant, B denotes a content (% by mass) of the crosslinking agent, and C denotes a content (% by mass) of the ionic surfactant in the reaction liquid based on a total mass of the reaction liquid.

14. An ink jet recording method for recording an image on a recording medium by using an aqueous ink, and an aqueous reaction liquid comprising a reactant reacting with the aqueous ink, the method comprising the steps of:
applying the reaction liquid to the recording medium, and
applying the aqueous ink to the recording medium by ejecting the aqueous ink from an ejection head of an ink jet system so that the aqueous ink overlaps at least a part of a region of the recording medium to which the reaction liquid is applied, wherein
the aqueous ink comprises a resin,
the reactant comprises at least one selected from the group consisting of a polyvalent metal salt and a cationic resin, and
the reaction liquid further comprises an ionic surfactant, and a crosslinking agent capable of forming a bond with the resin in the aqueous ink.

15. The ink jet recording method according to claim 14, wherein the step of applying the reaction liquid is a step of applying the reaction liquid to the recording medium by ejecting the reaction liquid from an ejection head of an ink jet system.

16. The ink jet recording method according to claim 14, wherein D/E is 0.5 or more to 6.0 or less where, in an image layer formed from the reaction liquid and the aqueous ink applied to the recording medium, E denotes an amount (μmol/m²) of functional groups in the crosslinking agent and D denotes an amount (μmol/m²) of functional groups in the resin per unit area of the recording medium.

17. An ink jet recording apparatus used in an ink jet recording method for recording an image on a recording medium by using an aqueous ink, and an aqueous reaction liquid comprising a reactant reacting with the aqueous ink, the ink jet recording apparatus comprising:
a reaction liquid applying unit for applying the reaction liquid to the recording medium, and
an ink applying unit for applying the aqueous ink to the recording medium by ejecting the aqueous ink from an ejection head of an ink jet system so that the aqueous ink overlaps at least a part of a region of the recording medium to which the reaction liquid is applied, wherein
the aqueous ink comprises a resin,
the reactant comprises at least one selected from the group consisting of a polyvalent metal salt and a cationic resin, and
the reaction liquid further comprises an ionic surfactant, and a crosslinking agent capable of forming a bond with the resin in the aqueous ink.
